(19) United States
(12) Patent Application Publication
(10) Pub. No.: US 2017/0325264 A1
(43) Pub. Date: Nov. 9, 2017

(54) BACKOFF TECHNIQUES FOR TRANSITIONING BETWEEN SINGLE-USER AND MULTI-USER MODES

(71) Applicant: QUALCOMM Incorporated, San Diego, CA (US)

(72) Inventors: George CHERIAN, San Diego, CA (US); Alfred ASTERJADHI, San Diego, CA (US); Simone MERLIN, San Diego, CA (US); Gwendolyn Denise BARRIAC, Encinitas, CA (US); Yan ZHOU, San Diego, CA (US)

(21) Appl. No.: 15/587,217

(22) Filed: May 4, 2017

Related U.S. Application Data
(60) Provisional application No. 62/409,859, filed on Oct. 18, 2016.
(60) Provisional application No. 62/333,745, filed on May 9, 2016.

(51) Int. Cl. H04W 74/08; H04W 74/00; H04B 7/0413; H04W 84/12

(52) U.S. Cl. CPC H04W 74/0816; H04W 74/006; H04B 7/0413; H04W 84/12

(57) ABSTRACT

Methods and apparatus for determining backoff values when transitioning between single-user (SU) and multi-user (MU) modes are provided. A station (STA) transitions from a Single-User (SU) mode, in which a first set of parameters is used to attempt to access a medium, to a Multi-User (MU) mode, in which a second set of parameters is used to attempt to access the medium. The STA determines, upon transitioning back from the MU mode to the SU mode, one or more values to use for setting corresponding one or more of a set of backoff counters. The STA attempts, after setting the one or more backoff counters, to access the medium for one or more SU transmissions based on the set of backoff counters.

This application claims priority to U.S. Provisional Application Ser. No. 62/333,745, entitled “BACKOFF TECHNIQUES FOR TRANSITIONING BETWEEN SINGLE-USER AND MULTI-USER MODES”, filed on May 9, 2016, and U.S. Provisional Application Ser. No. 62/409,859, entitled “BACKOFF TECHNIQUES FOR TRANSITIONING BETWEEN SINGLE-USER AND MULTI-USER MODES”, filed on Oct. 18, 2016, which are expressly incorporated by reference in their entirety.

### FIELD

Certain aspects of the present disclosure generally relate to wireless communications and, more particularly, to backoff techniques when a wireless device transmissions between single-user (SU) and multi-user (MU) modes.

### BACKGROUND

In order to address the issue of increasing bandwidth requirements demanded for wireless communications systems, different schemes are being developed to allow multiple user terminals to communicate with a single access point by sharing the channel resources while achieving high data throughputs. Multiple-input multiple-output (MIMO) technology represents one such approach that has recently emerged as a popular technique for next generation communication systems. MIMO technology has been adopted in several emerging wireless communications standards, such as the Institute of Electrical and Electronics Engineers (IEEE) 802.11 standard. The IEEE 802.11 standard denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single Access Point (AP) and multiple user stations (STAs), concurrent transmissions may occur on multiple channels toward different stations, both in the uplink and downlink direction. Many challenges are present in such systems.

### SUMMARY

Certain aspects of the present disclosure provide a method for wireless communications by a station (STA). The method generally includes transitioning from a Single-User (SU) mode, in which a first set of parameters is used to attempt to access a medium, to a Multi-User (MU) mode, in which a second set of parameters is used to attempt to access the medium, determining, upon transitioning back from the MU mode to the SU mode, values for setting one or more backoff counters of a set of backoff counters, and attempting, after setting the one or more backoff counters, to access the medium for one or more SU transmissions based on the set of backoff counters.

Certain aspects of the present disclosure provide a method for wireless communication by a Base Station (BS). The method generally includes detecting that at least one Station (STA) has data to transmit on a medium, and attempting to access the medium based on a first set of parameters to transmit a trigger frame to the at least one STA, the trigger frame scheduling resources for transmitting the data in a Multi-User (MU) mode, wherein one or more parameters of the first set of parameters are different from one of more parameters of a second set of parameters for attempting to access the medium in a Single-User (SU) mode and one or more parameters of a third set of parameters for attempting to access the medium in a Multi-User (MU) mode.

Certain aspects of the present disclosure provide an apparatus for wireless communication by a User Equipment (UE). The apparatus generally includes means for transitioning from a Single-User (SU) mode, in which a first set of parameters is used to attempt to access a medium, to a Multi-User (MU) mode, in which a second set of parameters is used to attempt to access the medium, means for determining, upon transitioning back from the MU mode to the SU mode, values for setting one or more backoff counters of a set of backoff counters, and means for attempting, after setting the one or more backoff counters, to access the medium for one or more SU transmissions based on the set of backoff counters.

Certain aspects of the present disclosure provide an apparatus for wireless communication by a Base Station (BS). The apparatus generally includes means for detecting that at least one Station (STA) has data to transmit on a medium, and means for attempting to access the medium based on a first set of parameters to transmit a trigger frame to the at least one STA, the trigger frame scheduling resources for transmitting the data in a Multi-User (MU) mode, wherein one or more parameters of the first set of parameters are different from one or more parameters of a second set of parameters for attempting to access the medium in a Single-User (SU) mode and one or more parameters of a third set of parameters for attempting to access the medium in the MU mode.

Aspects of the present disclosure also provide various methods, means, and computer program products corresponding to the apparatuses and operations described above.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 illustrates example operations performed by a station (STA) in a WLAN network, in accordance with certain aspects of the present disclosure.

FIG. 4 illustrates example scenarios for determining values of backoff counters by an STA, in accordance with certain aspects of the present disclosure.

FIG. 5 illustrates example operations performed by an Access Point (AP) for transmitting a trigger frame, in accordance with certain aspects of the present disclosure.

FIG. 6 illustrates example format of the MU EDCA Parameter Set element, in accordance with certain aspects of the present disclosure.

FIG. 7 illustrates example formats of MU AC_BE, MU AC_BK, MU AC_VI, and MU AC_VO Parameter Record fields, in accordance with certain aspects of the present disclosure.

### DETAILED DESCRIPTION

IEEE 802.11 based Wireless Local Area Network (WLAN) technology has been widely deployed to provide broadband services. The next generation WLAN standard, IEEE 802.11ax has commenced the standardization of new Medium Access Control (MAC) and PHY layers for further performance improvement. IEEE 802.11ax targets to provide at least four times improvement in the average throughput per station (STA) in a dense deployment scenario, while maintaining or improving the power efficiency per station.

One representative characteristic of WLANs is the use of Carrier Sense Multiple Access with Collision Avoidance (CSMA/CA) as MAC protocol. In CSMA/CA, a node listens to the communication channel when it has a packet ready for transmission. Once the node detects that the channel is free (i.e., the energy level on the channel is lower than the CCA (Clear Channel Assessment) threshold), the node starts a backoff procedure by selecting a random initial value for the backoff counter. The node then starts decreasing the backoff counter while sensing the channel. When the backoff counter reaches zero, the node starts transmitting. As the number of Wi-Fi devices in use increases, Carrier Sense Multiple Access (CSMA) inefficiencies in legacy Wi-Fi can lead to degradation in per user throughput.

In order to alleviate the above mentioned heavy channel access load problem and to avoid resource collisions, multi-user (MU) PHY as defined by 802.11ax includes centralized allocation of resources. 802.11ax generally supports a single-user (SU) mode and a multi-user (MU) mode. The SU mode generally is the same as legacy SU access allowing contention based access to stations one at a time. The MU mode (or the scheduled mode) allows multiple STAs to be scheduled for simultaneous transmission on the uplink. In certain aspects, STAs may transition between the SU mode and the MU mode.

Certain aspects of the present disclosure discuss techniques to determine values of one or more backoff counters of the SU mode when transitioning from the MU mode to the SU mode. In accordance with certain aspects, an STA transitions from a SU mode, in which a first set of parameters is used to attempt to access a medium, to a MU mode, in which a second set of parameters is used to attempt to access the medium. The STA determines, upon transitioning back from the MU mode to the SU mode, values for setting one or more backoff counters of a set of backoff counters, and attempts, after setting the one or more backoff counters, to access the medium for one or more SU transmissions based on the set of backoff counters.

In accordance with certain aspects a Base Station (BS) detects that at least one STA has data to transmit on a medium and attempts to access the medium based on a first set of parameters to transmit a trigger frame to the at least one STA. The trigger frame schedules resources for transmitting the data in a Multi-User (MU) mode. In an aspect, one or more parameters of the first set of parameters are different from one or more parameters of a second set of parameters for attempting to access the medium in a Single-User (SU) mode and one or more parameters of a third set of parameters for attempting to access the medium in the MU mode.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

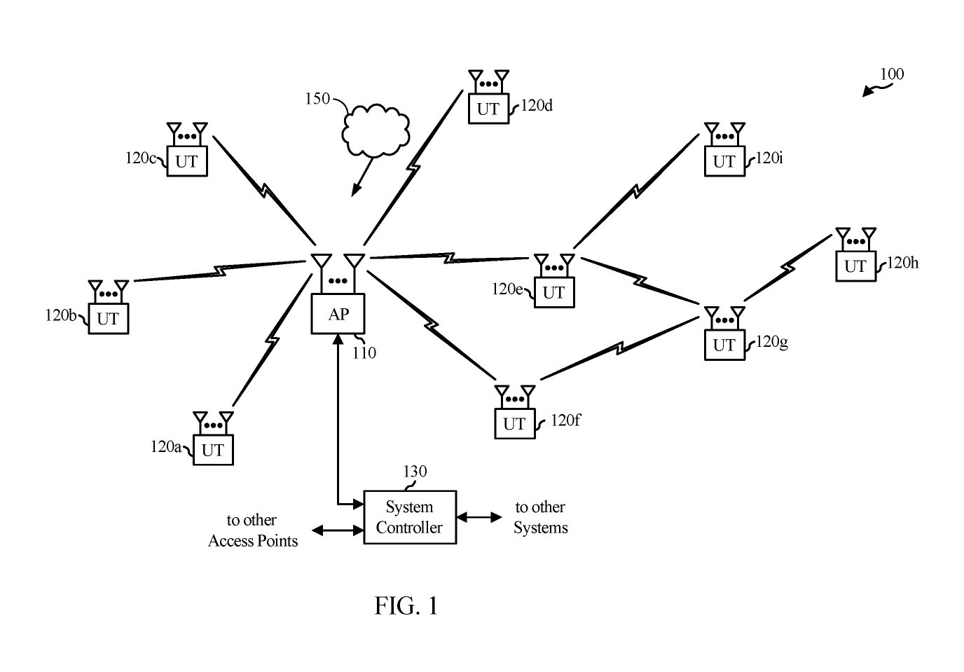

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

In accordance with certain aspects, an STA (e.g. user terminal 120), transitions from a SU mode, in which a first set of parameters is used to attempt to access a medium, to a MU mode, in which a second set of parameters is used to attempt to access the medium. The STA determines, upon transitioning back from the MU mode to the SU mode, values for setting one or more backoff counters of a set of backoff counters, and attempts, after setting the one or more backoff counters, to access the medium for one or more SU transmissions based on the set of backoff counters.

In accordance with certain aspects, a Base Station (BS) (e.g., AP 110) detects that at least one STA (e.g. user terminal 120) has data to transmit on a medium and attempts to access the medium based on a first set of parameters to transmit a trigger frame to the at least one STA. the trigger frame scheduling resources for transmitting the data in a Multi-User (MU) mode. In an aspect, one or more parameters of the first set of parameters are different from one or more parameters of a second set of parameters for attempting to access the medium in a Single-User (SU) mode and one or more parameters of a third set of parameters for attempting to access the medium in the MU mode.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

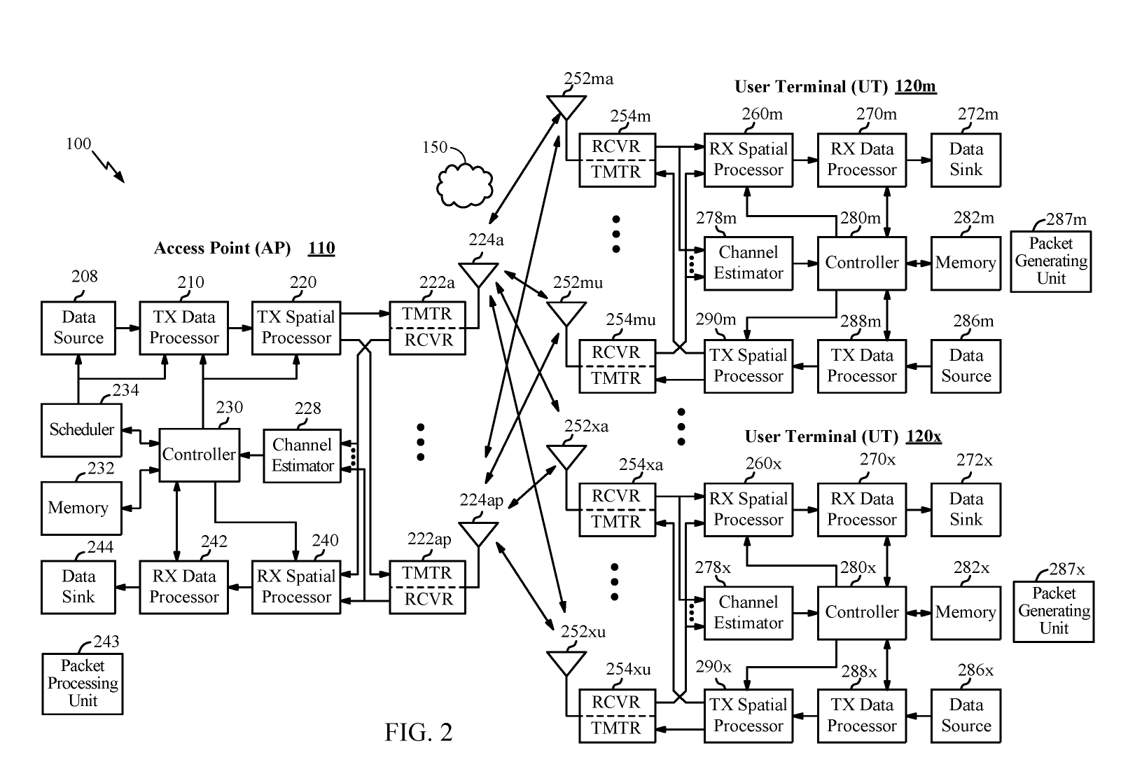

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} or that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

As illustrated, in FIGS. 1 and 2, one or more user terminals 120 may send one or more High Efficiency WLAN (HEW) packets 150, with a preamble format, to the access point 110 as part of a UL MU-MIMO transmission, for example. Each HEW packet 150 may be transmitted on a set of one or more spatial streams (e.g., up to 4). For certain aspects, the preamble portion of the HEW packet 150 may include tone-interleaved LTFs, subband-based LTFs, or hybrid LTFs.

The HEW packet 150 may be generated by a packet generating unit 287 at the user terminal 120. The packet generating unit 287 may be implemented in the processing system of the user terminal 120, such as in the TX data processor 288, the controller 280, and/or the data source 286.

After UL transmission, the HEW packet 150 may be processed (e.g., decoded and interpreted) by a packet processing unit 243 at the access point 110. The packet processing unit 243 may be implemented in the process system of the access point 110, such as in the RX spatial processor 240, the RX data processor 242, or the controller 230. The packet processing unit 243 may process received packets differently, based on the packet type (e.g., with which amendment to the IEEE 802.11 standard the received packet complies). For example, the packet processing unit 243 may process a HEW packet 150 based on the IEEE 802.11 HEW standard, but may interpret a legacy packet (e.g., a packet complying with IEEE 802.11a/b/g) in a different manner, according to the standards amendment associated therewith.

### Example Backoff Techniques for Transitioning Between Single-User and Multi-User Modes

IEEE 802.11 based Wireless Local Area Network (WLAN) technology has been widely deployed to provide broadband services. The next generation WLAN standard, IEEE 802.11ax has commenced the standardization of new Medium Access Control (MAC) and PHY layers for further performance improvement. IEEE 802.11ax targets to provide at least four times improvement in the average throughput per station (STA) in a dense deployment scenario, while maintaining or improving the power efficiency per station. Since, IEEE 802.11ax considers a dense deployment scenario, heavy traffic load is one of the basic assumptions of the next generation WLAN. It is well known that MAC access delay exponentially increases as number of users increases in WLAN.

One representative characteristic of WLANs is the use of Carrier Sense Multiple Access with Collision Avoidance (CSMA/CA) as MAC protocol. It offers a reasonable trade-off between performance, robustness and implementation costs. In CSMA/CA, a node listens to the communication channel when it has a packet ready for transmission. Once the node detects that the channel is free (i.e., the energy level on the channel is lower than the CCA (Clear Channel Assessment) threshold, the node starts a backoff procedure by selecting a random initial value for a backoff counter. The node then starts decreasing the backoff counter while continuing to sense the channel. Whenever a transmission, from either other nodes within the same WLAN or those belonging to other WLANs, is detected on the channel, the backoff counter is paused until the channel is detected free again, at which point the countdown is resumed. When the backoff counter reaches zero, the node starts transmitting on the channel.

Quality of service (QoS) may be implemented by utilizing several access categories (AC) which help effectively establish a different back-off generation procedure per queue, where each AC uses a different queue. For each queue, different priorities assigned to each AC effectively help establish a different probability of gaining access to a wireless medium. For example, if packets of different ACs are ready for transmission when a backoff timer expires, the access category with the higher priority may be granted access. Several backoff counters may be implemented with one or more different AC queues per counter (e.g., sharing one transmitter).

With the popularity of smartphones and social networking applications, users often upload their own contents to share with their peers. In today's WLAN networks, if these users' devices are connected to a same Access Point (AP), they have to contend for radio resources and transmit their contents sequentially one at a time. Further, providing high data rates in scenarios where the density of WLAN users is very high (e.g., 1 user/m²) requires the deployment of many APs placed close to each other (e.g., within 5-10 m of one another). Examples of such high density of WLAN users include a stadium, a train, an apartment building etc. In these dense scenarios, most relevant challenges are related to interference issues, which increase the packet error rate and reduce the number of concurrent transmissions in a given area by preventing neighboring WLANs from accessing the channel. Additionally, the presence of many STAs in the same area increases the chances that the backoff counters of two or more STAs reach zero simultaneously, which results in a collision.

Moreover, as the number of Wi-Fi devices in use increases, CSMA inefficiencies in legacy Wi-Fi can lead to degradation in per user throughput. One goal of 802.11ax is to increase the efficiency of the technology and achieve 4x improvement in the average user throughput.

As noted above, in the next generation WLAN, heavy traffic load situation by dense user population is expected. Since WLAN employs contention based distributed channel access, heavy traffic causes very long channel access delays. One of the key enabling technologies in the next generation WLAN (e.g., 802.11ax) is OFDMA. In the conventional Distributed Coordination Function (DCF) channel access and wider bandwidth operation, a single user is allowed to a channel at a given time. In OFDMA, however, multiple users are allowed to access channels at the same time.

In order to alleviate the above mentioned heavy channel access load problem and to avoid resource collisions, multi-user (MU) PHY is defined by 802.11ax which includes centralized allocation of resources. 802.11ax generally supports a single-user (SU) mode and a multi-user (MU) mode. The SU mode generally is the same as legacy SU access allowing contention based access to stations one at a time. The MU mode (or the scheduled mode) allows multiple MU capable STAs to be scheduled for simultaneous transmission on the uplink. In the MU mode, a serving AP generally performs the function of the coordinator by broadcasting a trigger frame scheduling resources (e.g., time and frequency resources) for multiple MU capable STAs for simultaneous UL transmissions. Once receiving the trigger frame, each MU capable STA transmits on the UL using its corresponding scheduled resources. The UL transmissions from the multiple scheduled STAs may generally be simultaneous and orthogonal.

Generally, 802.11ax supporting both the SU and MU modes has opposing requirements. One is that an STA having data to be transmitted should be able to transmit its data and the second is that AP should schedule this data transmission so that STA does not transmit data on its own. In order to satisfy these opposing requirements, one technique implemented in 802.11ax includes allowing MU capable STAs to operate in SU mode by default. So, by default, whenever an STA has data to transmit, it may send its data according to legacy SU mode mechanisms. The first SU packet, in the SU header of the STA's UL transmission may have an indication that the STA has more data to send. In response, the AP may schedule (e.g, by sending a trigger frame) the STA for transmission of subsequent data packets. Once the STA receives the trigger frame scheduling UL resources, the STA may switch to the MU mode and transmit data packets using the scheduled resources.

In certain aspects, the STA may not be able to accommodate all data packets that need to be transmitted in one set of scheduled resources and may need to receive several trigger frames scheduling more resources to complete its transmission. For example, there may be different Access Categories (ACs) in the SU mode and one or more ACs may have their own corresponding backoff counters. When a STA having multiple ACs receives a trigger frame scheduling UL resources to the STA for MU mode transmissions, the STA may not be able to accommodate data packets (e.g., stored in its buffer) for all the ACs in the scheduled resources. Generally, the AP continues to schedule more resources using subsequent trigger frames enabling the STA to transmit data packets corresponding to all ACs.

However, in certain aspects, the AP may fail to schedule the STA for transmission of UL data packets while the STA is in the MU mode. For example, the STA may fail to successfully receive a subsequent trigger frame from a serving AP before a preconfigured timeout period. In such cases, the STA may be allowed to switch back to the SU mode for performing the remaining transmissions. The STA may switch back to the MU mode when it receives another trigger frame.

Certain aspects of the present disclosure discuss techniques to determine values of one or more backoff counters of the SU mode when transitioning from the MU mode to the SU mode.

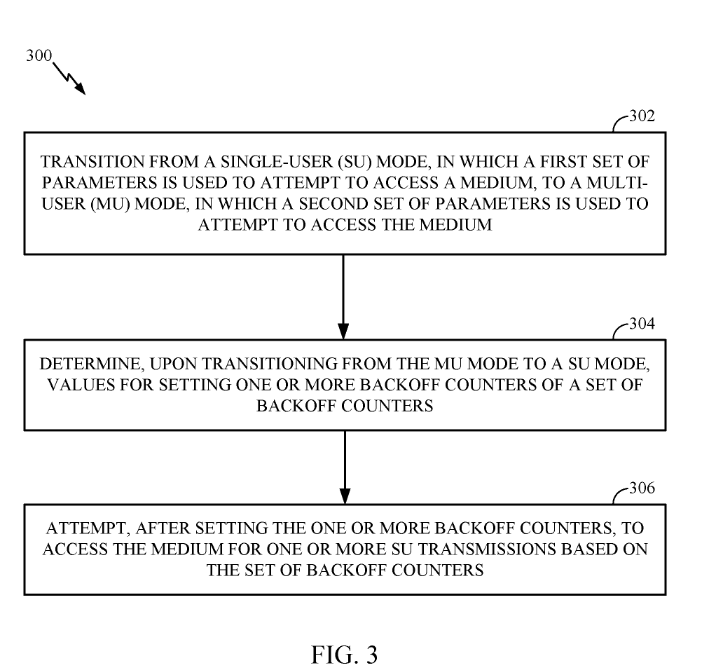

FIG. 3 illustrates example operations 300 performed by a station (STA) in a WLAN network, in accordance with certain aspects of the present disclosure. Operations 300 begin, at 302, by transitioning from a SU mode, in which a first set of parameters is used to attempt to access a medium, to a MU mode, in which a second set of one or more parameters is used to attempt to access the medium. At 304, the STA determines, upon transitioning back from the MU mode to the SU mode, values for setting one or more backoff counters of a set of backoff counters. At 306, the STA attempts, after setting the one or more backoff counters, to access the medium for one or more SU transmissions based on the set of backoff counters.

In certain aspects, after transitioning back to the SU mode, the STA may determine values of one or more backoff counters based on the second set of parameters (e.g., MU Enhanced Distributed Channel Access (EDCA) parameter set) defined for the MU mode of operation. In an aspect, the second set of parameters is different from the first set of parameters (e.g., SU EDCA parameter set) defined for the SU mode of operation. Thus, the values of the backoff counters for the SU mode transmissions based on the second set of MU mode parameters is different from the values of the backoff counters based on the first set of SU mode parameters.

In certain aspects, the STA may start operating in a default SU mode before transitioning to the MU mode, for example, in response to receiving a trigger frame. In certain aspects, when the STA transitions back from the MU mode to the SU mode, a relaxed (e.g., less aggressive than default SU mode) SU mode approach may be implemented so that the STA in the relaxed SU mode attempts to gain access to the channel in a manner that is less aggressive. For example, additional Enhanced Distributed Channel Access (EDCA) parameters are defined for implementing the relaxed SU mode of operation. In an aspect, one or more EDCA parameters used for the relaxed SU mode of operation are different from one or more EDCA parameters used for the default SU mode of operation. For example, the new EDCA parameter set may include a higher value for one or more backoff counters (e.g., corresponding to one or more ACs) in the SU mode. In certain aspects, the relaxed SU operation implemented via a longer backoff counter may allow the AP sufficient time to schedule the STA for MU operation, thus, avoiding premature SU transmissions by the STA before the STA can be scheduled for MU operation. In an aspect, one or more SU mode backoff counters of the STA may be reset to their corresponding predetermined values (e.g., less aggressive values) when the STA transitions from the MU mode to the SU mode. Since the backoff counters are reset to the longer backoff values, the AP may have a chance to send a trigger frame to the STA preempting the SU transmissions. This may help the system to operate more in the scheduled MU mode and less in the unscheduled SU mode. In an aspect, backoff counters used for both the default SU mode and the relaxed SU mode are reset to predetermined values (e.g., longer backoff values).

In certain aspects, different EDCA parameters may be defined for the default SU mode (e.g., legacy SU mode) that may be used by the STA for initial channel access as noted above, and a relaxed (e.g., less aggressive) SU mode implemented when the STA is forced to switch from the MU mode to the SU mode, for example, as a result of failure to receive trigger frames from a serving AP. For example, lower values may be selected for one or more SU mode backoff counters in the default SU mode and higher values may be selected for one or more backoff counters in the relaxed SU mode. In certain aspects, the default SU mode may use the SU mode EDCA parameters and the relaxed SU mode may use one or more MU mode EDCA parameters to transmit SU packets. Thus, relaxed values of the backoff counters used for SU transmissions in the relaxed SU mode may be set based on the additional EDCA parameters included as part of the MU mode EDCA parameters.

In certain aspects, the EDCA parameters including the values of the backoff counters may be transmitted by a serving AP to its served stations.

In certain aspects, the transition from the SU mode to the MU mode is based on the STA successfully responding to a trigger frame received by the STA. For example, in response to receiving a trigger frame from an AP, the STA may transmit data to the AP based on resources scheduled by the trigger frame. The STA may determine that it has successfully responded to the trigger frame when it receives acknowledgement from the AP indicating that the data was received by the AP.

In certain aspects, while resetting the SU mode backoff counters (e.g., to relaxed backoff values) is a simple technique and helps preempt SU mode transmissions by scheduling STAs in MU mode, SU transmissions (e.g., default SU mode transmissions) may suffer as a result of resetting all SU mode backoff counters.

In certain aspects, when transitioning from the SU mode to the MU mode, the STA may store values of one or more SU backoff counters (e.g. used by SU users). When transitioning back to the SU mode, the STA may restore (e.g., restart) the SU backoff counters from their corresponding stored values. However, in an aspect, a MU backoff counter (e.g., a backoff counter used by MU users for SU transmissions after transitioning from the MU mode back to the SU mode) is reset. In this case, scheduling benefits are still maintained since scheduling is expected only for MU users, while SU performance is not degraded.

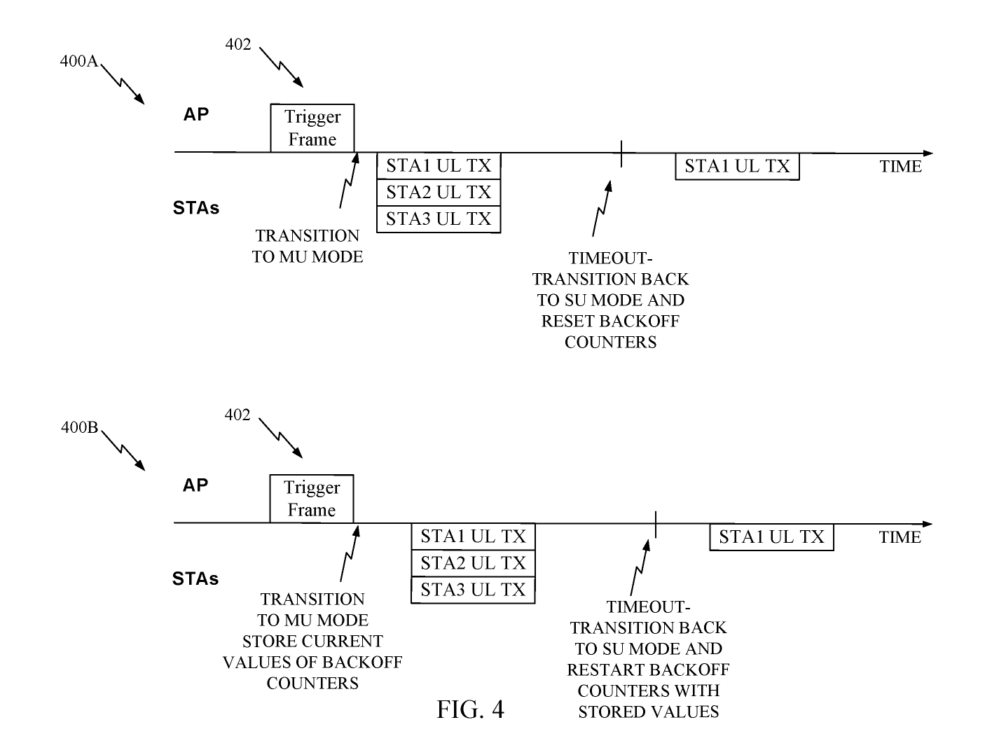

FIG. 4 illustrates example scenarios 400A and 400B for determining values of backoff counters by an STA, in accordance with certain aspects of the present disclosure.

As shown in 400A, a trigger frame 402 is transmitted by AP at 402 scheduling UL resources for stations STA1, STA2, and STA3 for simultaneous UL transmissions. One or more of the STAs may be operating in a default SU mode before receiving the trigger frame from the AP. In response to receiving the trigger frame 402, the STAs 1-3 transition to the MU mode and, simultaneously transmit packets on the UL on resources scheduled by the trigger frame 402. The AP does not transmit another trigger frame before a predetermined timeout period expires. In an aspect, the AP may transmit another trigger frame before the timeout period expires, but one or more STAs may not receive it, for example, due to interference. Once the timeout period expires, each STA transitions back to an SU mode (e.g., a relaxed SU mode). However, STA 1 may not have sent all its data packets using the resources scheduled by the trigger frame 402. Thus, STA1 may reset one or more of its SU mode backoff counters to predetermined values (e.g., relaxed backoff values) and attempt to transmit the remaining packets as SU transmissions once the counters expire. In an aspect, as shown in 400A, STA1 may receive another trigger frame scheduling more resources before its reset backoff counter expires. In such a case, STA1 resumes transmission in the MU mode based on the received trigger frame.

As shown in 400B, upon receiving the trigger frame 402, one or more of the STAs 1-3 may store values of one or more of their SU mode backoff counters, for example before transitioning to the MU mode. As discussed above with respect to 400A, STAs 1-3 simultaneously transmit packets on the UL in the MU mode, on resources scheduled by the trigger frame 402. However, when the timeout occurs, instead of resetting the backoff counters, STA1 may restore the stored values of the SU backoff counters and attempt to transmit remaining packets when the timers expire. In an aspect, after transitioning back to the SU mode, STA 1 may reset a MU backoff counter and may receive another trigger frame before the MU backoff counter expires. In such a case, as shown in 400B, STA 1 resumes transmission in the MU mode based on the received trigger frame.

In certain aspects, a serving AP may attempt to access a medium based on a set of parameters (e.g., EDCA parameters) to transmit a trigger frame. In an aspect, one or more parameters of the set of parameters used by the AP for transmitting the trigger frame is different from one of more parameters (e.g., EDCA parameters) for attempting to access the medium in a Single-User (SU) mode and one or more parameters of a set of parameters for attempting to access the medium in a Multi-User (MU) mode.

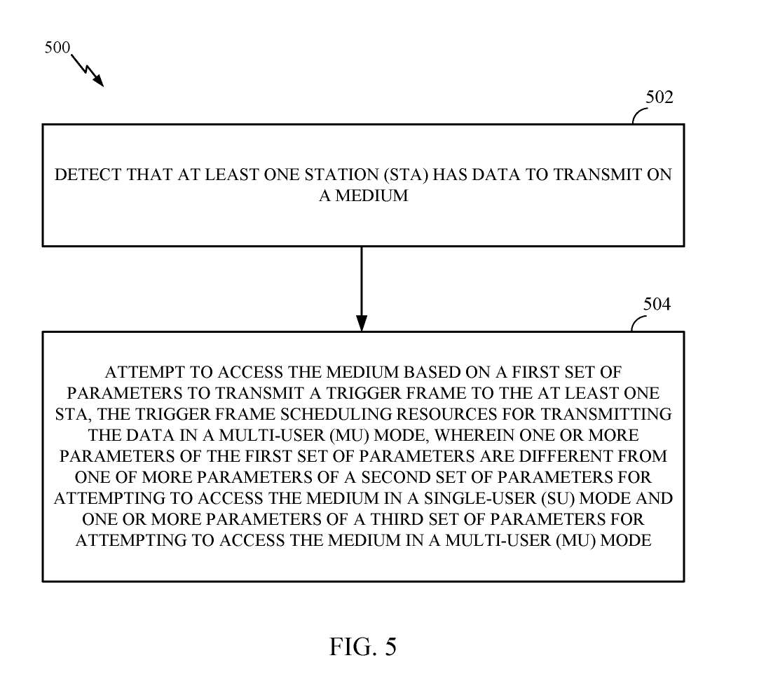

FIG. 5 illustrates example operations 500 performed by an AP for transmitting a trigger frame, in accordance with certain aspects of the present disclosure. Operations 500 begin, at 502 by detecting that at least one Station (STA) has data to transmit on a medium. At 504, the AP attempts to access the medium based on a first set of parameters to transmit a trigger frame to the at least one STA, the trigger frame scheduling resources for transmitting the data in a MU mode. In an aspect, the one or more parameters of the first set of parameters are different from one or more parameters of a second set of parameters for attempting to access the medium in a Single-User (SU) mode and one or more parameters of a third set of parameters for attempting to access the medium in the MU mode.

In certain aspects, the parameters of the first, second and third sets of parameters include EDCA parameters. In certain aspects, the third set of parameters for attempting to access the medium in the MU mode includes parameters used to access the medium for SU transmissions after an STA transitions back from the MU mode to the SU mode.

In certain aspects, the AP may adjust one or more values of the first set of parameters based on a number of attempts to access the medium by one or more STAs in the SU mode. In an aspect, a large number of attempts to access the medium in the SU mode indicates that the system is close to saturation. In certain aspects, when the system starts to get saturated (e.g., indicated by a large number of SU attempts to access the medium), the AP may preempt the SU attempts to access the medium by sending the trigger frame to force the STAs to operate in the MU mode. In an aspect, when the AP detects that the system is starting to get saturated, the AP may use a more aggressive value of the parameters to send a trigger frame.

### MU EDCA Parameter Set Element

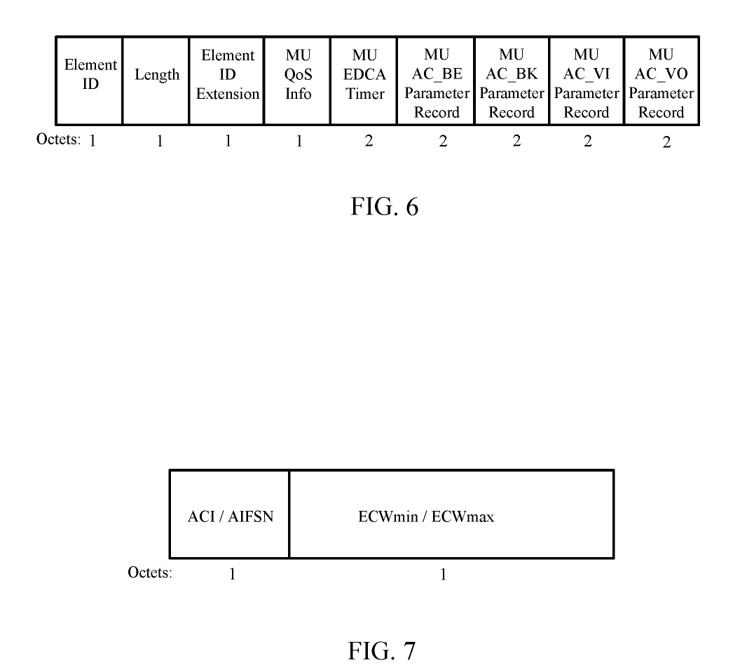

The EDCA Parameter Set element generally provides information needed by STAs for proper operation of the QoS facility during a Contention Period (CP). The format of the MU EDCA Parameter Set element (e.g., used for the MU mode of operation) is illustrated in FIG. 6. The Element ID and Length fields are defined in the 802.11 standards.

For an infrastructure Basic Service Set (BSS), the MU EDCA Parameter Set element may be used by the AP to establish policy (by changing default Management Information Base (MIB) attribute values), to change policies when accepting new STAs or new traffic, or to adapt to changes in offered load. The most recent MU EDCA Parameter Set element received by a STA may be used to update the appropriate MIB values.

The format of the MU QoS Info field is the same as the QoS Info field defined in the standards. The MU QoS Info field contains the EDCA Parameter Set Update Count subfield, which is initially set to 0 and is incremented each time any of the AC parameters changes. This subfield may be used by non-AP STAs to determine whether the MU EDCA parameter set has changed and may require updating the appropriate MIB attributes.

The MU EDCA Timer indicates the duration of time, in Time Units (TUs), for which the provided MU EDCA parameters are valid after reception of a Trigger frame.

In an aspect, the formats of MU AC_BE, MU AC_BK, MU AC_VI, and MU AC_VO Parameter Record fields are identical and are illustrated in FIG. 7. The format of the ACI/AIFSN field as shown in FIG. 7 is illustrated in the 802.11 standards and the encoding of its subfields is defined in the standards. The format of the ECWmin/ECWmax field is illustrated in the standards and the encoding of its subfields is defined in the standards.

STA Behavior for Switching from SU to MU in Unscheduled Mode

A High Efficiently (HE) non-AP STA that receives a trigger frame (e.g., Basic variant Trigger frame) that contains a Per User Info field with the AID of the STA may update its EDCA parameters, for example, dot11EDCATableCWmin, dot11EDCATableCWmax, dot11EDCATableAIFSN, and dot11HEMUEDCATimer to the values contained in the most recently received MU EDCA Parameter Set element sent by the AP to which the STA is associated. In an aspect, the dot11HEMUEDCATimer may uniformly count down to 0 when its value is nonzero.

An HE STA may update its EDCA parameters, for example, dot11EDCATableCWmin, dot11EDCATableCWmax, and dot11EDCATableAIFSN to the values contained in the most recently received EDCA Parameter Set element sent by the AP to which the STA is associated or to the default, e.g., dot11EDCATable when an EDCA Parameter Set element has not been received when the dot11HEMUEDCATimer reaches 0.

STA Behavior for Switching from SU Mode to MU Mode in Scheduled Mode (e.g., Target Wake Time (TWT))

In certain aspects, a TWT STA may update the MIB attributes. At each implicit TWT service period (SP) or trigger-enabled TWT SP end time, the STA may update the EDCA parameters, for example, dot11EDCATableCWmin, dot11EDCATableCWmax, and dot11EDCATableAIFSN to the values contained in the most recently received MU EDCA Parameter Set element sent by the AP to which it is associated, if one is provided by the AP. Otherwise, the STA may not update the values for the parameters. In an aspect, an implicit TWT SP period is a period of time during which the STA does not expect the AP to transmit a trigger frame to it

In certain aspects, at each implicit TWT SP start time, the STA may update the EDCA parameters, for example, dot11EDCATableCWmin, dot11EDCATableCWmax, and dot11EDCATableAIFSN to the values contained in the most recently received EDCA Parameter Set element sent by the AP to which it is associated, if one is provided by the AP. Otherwise the EDCA parameters may be set to the default values for the parameters as defined under “HCF (Hybrid Coordination Function) contention based channel access (EDCA)” in the standards.

In certain aspects, at each trigger-enabled TWT SP start time, the STA may update the dot11MUEDCATimer to the value of the trigger-enabled TWT SP duration and upon expiration of the timer the STA may update dot11EDCATableCWmin, dot11EDCATableCWmax, and dot11EDCATableAIFSN to the values contained in the most recently received EDCA Parameter Set element sent by the AP to which it is associated, if one is provided by the AP. Otherwise these parameters are set to the default values for the parameters defined under “HCF contention based channel access (EDCA)” in the standards. In an aspect, a trigger enabled TWT SP is a period of time during which the STA expects the AP to transmit a trigger frame to it. Further, generally the MU EDCA parameters provide lower priority access to the STAs with respect to their SU EDCA parameters counter parts.

When switching to SU mode, STAs may decide how to restart backoff with SU mode EDCA parameters or use SU mode EDCA parameters after ongoing backoff finishes for that AC. In some cases, when switching to SU mode for an AC, a STA may stop ongoing backoff and restart backoff with SU mode EDCA parameters for that AC. In other cases, when switching to SU mode for an AC, a STA may continue ongoing backoff and (only) use SU mode EDCA parameters for new backoffs for that AC. In other cases, when switching to SU mode for an AC, STA may dynamically decide whether to restart backoff with SU mode EDCA parameters or wait until expiration of the ongoing backoff timer before using SU mode EDCA parameters to restart the backoff timer. In an aspect, the STA may decide, based on an amount of time remaining before expiration of an ongoing backoff timer for an AC, whether to stop the backoff timer and restart the backoff timer based on the SU mode EDCA parameters for the AC For example, STA may decide to continue ongoing backoff if it is almost finished, e.g. remaining backoff time is below 10% of total backoff time.

In another aspect, a STA may stay in the SU mode for all ACs and use SU mode EDCA parameters for pre-association communications with an AP. For example, STA may use SU mode EDCA parameters to send probe or association request to AP before receiving association response or assigned association ID.

In another aspect, a STA may stay in the SU mode and use SU mode EDCA parameters after association with an AP but before being scheduled by the AP. For example, “scheduled by the AP” here means STA receives from the AP a basic variant trigger frame that contains a per user info field with the association ID of the STA, and receives an immediate response from the AP for the STA's transmitted trigger-based PPDU.

In another aspect, a STA may set all of its SU mode switching timers to 0 if it is in SU mode.

In another aspect, when STA enters sleep mode, it may have the various options to handle its SU mode switching timers. For example, in option 1, STA freezes all timers when entering sleep mode but resumes their countdown when leaving sleep mode. In option 2, STA stops all timers when entering sleep mode and sets them to 0 when leaving sleep mode. In option 3, STA continues to count down all timers after entering sleep mode and stops them individually if they become 0.

The various operations of methods described above may be performed by any suitable means capable of performing the corresponding functions. The means may include various hardware and/or software component(s) and/or module(s), including, but not limited to a circuit, an application specific integrated circuit (ASIC), or processor.

In some cases the operations 300 in FIG. 3 and operations 500 in FIG. 5 may be performed by a general purpose computer. As such, means for obtaining, generating, and/or selecting may also include one or more processors of such a general purpose computer.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communication by a Station (STA) comprising:
transitioning from a Single-User (SU) mode, in which a first set of parameters is used to attempt to access a medium, to a Multi-User (MU) mode, in which a second set of parameters is used to attempt to access the medium;
determining, upon transitioning back from the MU mode to the SU mode, values for setting one or more backoff counters of a set of backoff counters; and
attempting, after setting the one or more backoff counters, to access the medium for one or more SU transmissions based on the set of backoff counters.

2. The method of claim 1, wherein the values of the one or more backoff counters are based on the second set of parameters defined for the MU mode of operation, the values different from values of the one or more backoff counters based on the first set of parameters defined for the SU mode of operation.

3. The method of claim 1, wherein the set of backoff counters comprises backoff counters for different Access Categories (ACs).

4. The method of claim 1, wherein the determining comprises:
resetting the one or more backoff counters to a corresponding one or more predetermined values.

5. The method of claim 4, further comprising receiving the one or more predetermined values from an access point.

6. The method of claim 1, further comprising:
storing values of the one or more backoff counters, upon transitioning to the MU mode.

7. The method of claim 6, wherein the determining comprises:
restoring the one or more backoff counters to their corresponding stored values after transitioning back to the SU mode.

8. The method of claim 1, wherein the transition from the SU mode to the MU mode is based on reception of a trigger frame from an access point (AP), the trigger frame scheduling resources for MU transmissions by the STA.

9. The method of claim 8, wherein the transition from the SU mode to the MU mode is based on successfully responding to the trigger frame.

10. The method of claim 9, wherein successfully responding to the trigger frame comprises:
transmitting data to the access point on the resources scheduled by the trigger frame; and
receiving acknowledgement from the access point indicating that the data was received by the access point.

11. The method of claim 8, wherein the transition back to the SU mode is based on failure to receive, while in the MU mode, another trigger frame from the AP before expiration of a timeout period.

12. The method of claim 1, wherein the set of backoff counters comprises at least a first backoff counter for a first access category (AC), wherein the first set of parameters includes SU mode Enhanced Distributed Channel Access (EDCA) parameters;
further comprising:
receiving a frame indicating the SU mode EDCA parameters for at least the first access category (AC); and
the determining comprises determining to use the SU mode EDCA parameters for setting the first backoff counter.

13. The method of claim 12, wherein the determining comprises:
deciding to stop the first backoff counter for the first AC, after switching to the SU mode for the first AC; and
restarting the first backoff counter based on the SU mode EDCA parameters for the first AC.

14. The method of claim 12, wherein the determining comprises:
deciding to continue the first backoff counter for the first AC, after switching to the SU mode for the first AC; and
waiting until after expiration of the first backoff counter to restart the first backoff counter based on the SU mode EDCA parameters for the first AC.

15. The method of claim 12, wherein the determining comprises:
deciding, based on an amount of time remaining before expiration of the first backoff counter for the first AC, whether to stop the first backoff counter and restart the first backoff counter based on the SU mode EDCA parameters for the first AC.

16. The method of claim 12, wherein the determining comprises:
deciding to remain in the SU mode for the first AC and use the SU mode EDCA parameters for the first AC for pre-association communications.

17. The method of claim 12, wherein the determining comprises:
deciding to remain in the SU mode for a plurality of ACs including the first AC and use the SU mode EDCA parameters for the plurality of ACs for pre-association communications.

18. The method of claim 12, wherein the determining comprises:
remaining in the SU mode for the first AC;
using the SU mode EDCA parameters for the first AC after association with an access point (AP); and
switching to a multiple user (MU) mode for the first AC after being scheduled by the AP to send MU traffic.

19. A method for wireless communication by a Base Station (BS) comprising:
detecting that at least one Station (STA) has data to transmit on a medium;
attempting to access the medium based on a first set of parameters to transmit a trigger frame to the at least one STA, the trigger frame scheduling resources for transmitting the data in a Multi-User (MU) mode,
wherein one or more parameters of the first set of parameters are different from one or more parameters of a second set of parameters for attempting to access the medium in a Single-User (SU) mode and one or more parameters of a third set of parameters for attempting to access the medium in the MU mode.

20. The method of claim 19, wherein one or more values of the first set of parameters is adjusted based on a number of attempts to access the medium by one or more STAs in the SU mode.

21. An apparatus for wireless communication by a Station (STA) comprising:
means for transitioning from a Single-User (SU) mode, in which a first set of parameters is used to attempt to access a medium, to a Multi-User (MU) mode, in which a second set of parameters is used to attempt to access the medium;
means for determining, upon transitioning back from the MU mode to the SU mode, values for setting one or more backoff counters of a set of backoff counters; and
means for attempting, after setting the one or more backoff counters, to access the medium for one or more SU transmissions based on the set of backoff counters.

22. The apparatus of claim 21, wherein the values of the one or more backoff counters are based on the second set of parameters defined for the MU mode of operation, the values different from values of the one or more backoff counters based on the first set of parameters defined for the SU mode of operation.

23. The apparatus of claim 21, wherein the means for determining is configured to:
reset the one or more backoff counters to a corresponding one or more predetermined values.

24. The apparatus of claim 23, further comprising means for receiving the one or more predetermined values from an access point.

25. The apparatus of claim 21, further comprising:
means for storing values of the one or more backoff counters, upon transitioning to the MU mode.

26. The apparatus of claim 25, wherein the means for determining is configured to:
restore the one or more backoff counters to their corresponding stored values after transitioning back to the SU mode.

27. The apparatus of claim 21, wherein the transition from the SU mode to the MU mode is based on reception of a trigger frame from an access point (AP), the trigger frame scheduling resources for MU transmissions by the STA.

28. The apparatus of claim 27, wherein the transition from the SU mode to the MU mode is based on successfully responding to the trigger frame.

29. An apparatus for wireless communication by a Base Station (BS) comprising:
means for detecting that at least one Station (STA) has data to transmit on a medium;
means for attempting to access the medium based on a first set of parameters to transmit a trigger frame to the at least one STA, the trigger frame scheduling resources for transmitting the data in a Multi-User (MU) mode,
wherein one or more parameters of the first set of parameters are different from one or more parameters of a second set of parameters for attempting to access the medium in a Single-User (SU) mode and one or more parameters of a third set of parameters for attempting to access the medium in the MU mode.

30. The apparatus of claim 29, wherein one or more values of the first set of parameters is adjusted based on a number of attempts to access the medium by one or more STAs in the SU mode.
